(19) United States
(12) Patent Application Publication
(10) Pub. No.: US 2021/0266745 A1
(43) Pub. Date: Aug. 26, 2021

(54) UNWANTED CALL AND SMS PROTECTION

(71) Applicant: XCAST LABS, INC., Northfield, IL (US)

(72) Inventor: Vladimir Smelyansky, Glenview, IL (US)

(73) Assignee: XCAST LABS, INC., Northfield, IL (US)

(21) Appl. No.: 17/180,840

(22) Filed: Feb. 21, 2021

Related U.S. Application Data
(60) Provisional application No. 62/979,112, filed on Feb. 20, 2020.

(51) Int. Cl. H04W 12/088; H04W 4/14; H04M 3/436; H04W 12/108

(52) U.S. Cl. CPC H04W 12/088; H04W 12/108; H04M 3/436; H04W 4/14

(57) ABSTRACT

Embodiments may provide improved techniques to protect telephone users from unwanted calls, as well as unwanted SMS or other text messages. Embodiments may utilize white, gray and black lists and may create and process such lists. For example, a method may comprise receiving, at a call processing system, a call or message from an originator to a recipient user of the call processing system, determining, at the call processing system, whether the originator of the call or message is present in at least one of a plurality of lists of identifiers of originators of calls or messages, and handling, at the call processing system, the call or message differently based on which list of identifiers in which the originator is present.

### CROSS-REFERENCE TO RELATED APPLICATIONS

This application claims the benefit of U.S. Provisional App. No. 62/979,112, filed Feb. 20, 2020, the contents of which are incorporated herein in their entirety.

### BACKGROUND

The present invention relates to techniques to protect telephone users from unwanted calls, as well as unwanted SMS or other text messages.

The volume of unwanted calls continues growing and has become a major inconvenience to telephone users—the majority of people. There are different approaches to protect users against unwanted calls, but current solutions have a number of deficiencies. For example—Blocking anonymous calls covers a very small percentage of unwanted calls, plus it can block some “wanted” calls as well. For example, many doctors make anonymous calls from their cell phones. Blocking based on Automatic Number Identification (ANI) is very ineffective because operators rotate their ANIs and by the time an ANI is marked as bad, it may no longer be in use. Call screening and call captcha are very inconvenient to the legitimate callers and people do not like it.

Accordingly, a need arises for improved techniques to protect telephone users from unwanted calls, as well as unwanted SMS or other text messages.

### SUMMARY

Embodiments may provide improved techniques to protect telephone users from unwanted calls, as well as unwanted SMS or other text messages. Embodiments may utilize white, gray and black lists and may create and process such lists.

For example, in an embodiment, a method may be implemented in a computer system comprising a processor, memory accessible by the processor, and computer program instructions stored in the memory and executable by the processor, and the method may comprise receiving, at a call processing system, a call or message from an originator to a recipient user of the call processing system, determining, at the call processing system, whether the originator of the call or message is present in at least one of a plurality of lists of identifiers of originators of calls or messages, and handling, at the call processing system, the call or message differently based on which list of identifiers in which the originator is present.

In embodiments, the originator of a call may be identified based on an Automatic Number Identification (ANI). The originator of a message may be identified based on an identifier associated with the message, the identifier comprising at least one of a telephone number, a non-telephone number digit strings, and a network address. The recipient user has a plurality of lists of identifiers of originators of calls or messages and the call is handled using the recipient user's plurality of lists. At least some other users of the call processing system other than the recipient user have lists of identifiers of originators of calls or messages and the call is handled using at some of the lists of identifiers of the other users.

In an embodiment, a system may comprise a processor, memory accessible by the processor, and computer program instructions stored in the memory and executable by the processor to perform receiving, at a call processing system, a call or message from an originator to a recipient user of the call processing system, determining, at the call processing system, whether the originator of the call or message is present in at least one of a plurality of lists of identifiers of originators of calls or messages, and handling, at the call processing system, the call or message differently based on which list of identifiers in which the originator is present.

In an embodiment, a computer program product may comprise a non-transitory computer readable storage having program instructions embodied therewith, the program instructions executable by a computer, to cause the computer to perform a method that may comprise receiving, at a call processing system, a call or message from an originator to a recipient user of the call processing system, determining, at the call processing system, whether the originator of the call or message is present in at least one of a plurality of lists of identifiers of originators of calls or messages, handling, at the call processing system, the call or message differently based on which list of identifiers in which the originator is present.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of an embodiment of a communication environment in which the present techniques may be implemented.

FIG. 2 an exemplary flow diagram of a process of unwanted call and SMS protection according to embodiments of the present techniques.

FIG. 3 is an exemplary block diagram of a computer system, in which processes involved in the embodiments described herein may be implemented.

### DETAILED DESCRIPTION

Embodiments may provide improved techniques to protect telephone users from unwanted calls, as well as unwanted SMS or other text messages. Embodiments may utilize white, gray and black lists and may create and process such lists.

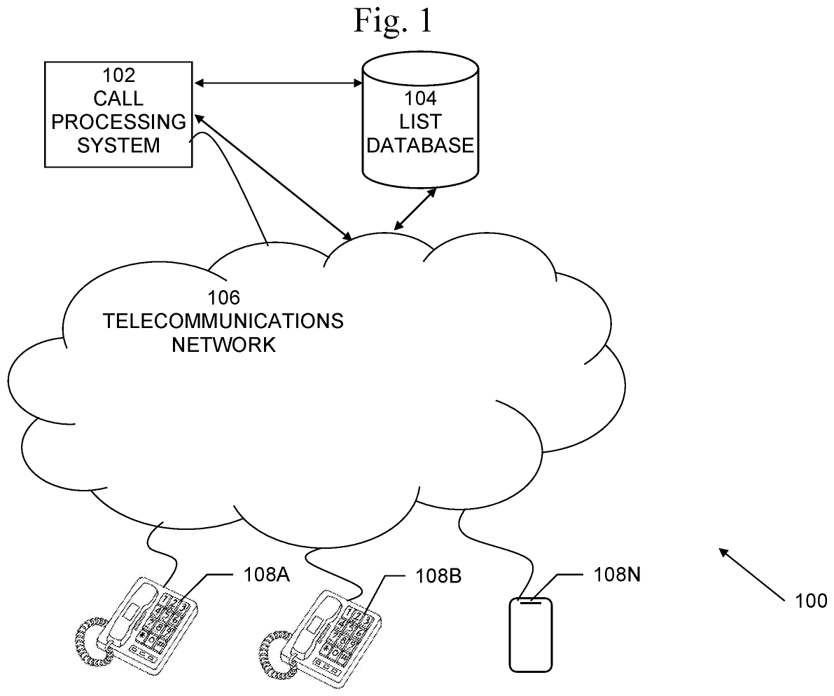

An exemplary communication environment 100, is shown in FIG. 1. In this example, distributed communication environment 100 may include one or more call processing systems 102, one or more list databases 104, a telecommunications network 106, and a plurality of user devices 108A-N, such as telephones, smartphones, etc. Call processing system 102 may include hardware and software to control the processing and completion of calls and messages to and from user devices 108A-N. Each call processing system 102 may communicate with one or more list databases 104, either directly or via telecommunications network 106. Telecommunications network 106 may include any arrangement of networks, including, for example, the Public Switched Telephone System, the Internet, private and proprietary networks, etc. User devices 108A-N may initiate and receive calls and messages with each other via telecommunications network 106 as controlled by call processing system 102.

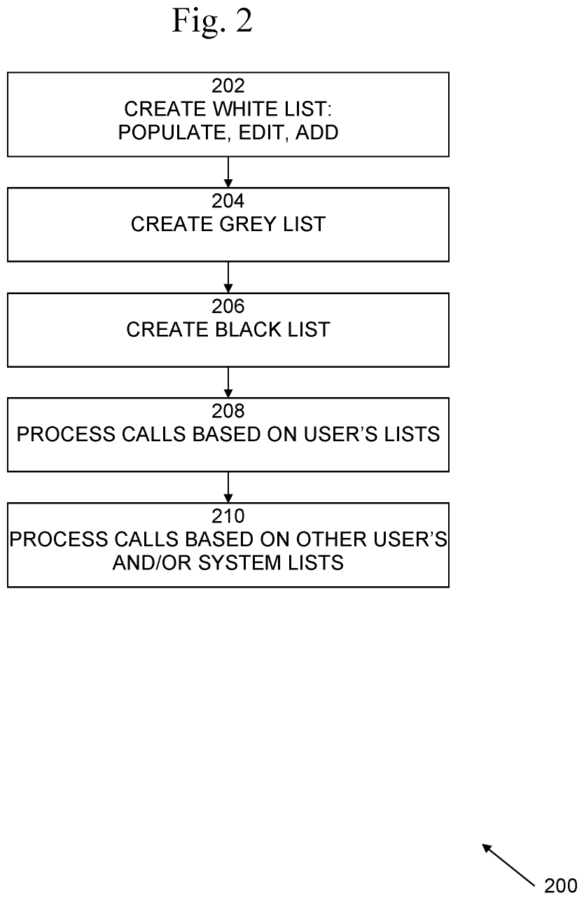

An exemplary process 200 of unwanted call and SMS protection is shown in FIG. 2. Although, for simplicity, process 200 is described in the context of a telephone call, process 200 may be employed to process message traffic, such as SMS messages, MMS messages, IMESSAGE® messages, text messages, etc. Embodiments that process telephone calls may utilize the Automatic Number Identification (ANI) to identify callers, and contact telephone numbers to identify list entries. Likewise, embodiments that process message traffic may use identifiers included in the message traffic, or message traffic headers, to identify senders of messages, and my use contact information to identify list entries. Such identifiers may include telephone numbers, non-telephone number digit strings, network addresses, such as IP addresses, email addresses, etc.

Process 200 begins with 202, in which a White List may be created. Embodiments may provide the ability to manually manage the White List by offering a front end or interface (GUI, web based or application) and to combine automatic population of the White List based on the user's contact list. For example, the White List creation flow may include automatically populating the White List from the user's contacts (phone book). Example of contacts may include individuals or some group lists, such as company email/PBX, etc. The White List may be manually edited as needed—add/delete/move/update entries. Additional entries may be added based on a phone call and/or message received. If call was accepted and the ANI was not in white list, the user (called party) may be provided with the ability to add the ANI to the White List. The number to be added could be from the phone or from a temporary list.

At 204, a Grey List may be created. Embodiments may provide automatic creation of the Grey List with the manual ability to manage the Grey List. For example, each call from an unknown (neither black nor white) ANI may be added to the Grey List. The user may be provided with a front end or interface (GUI, web based or application), for example included in the same interface as the White List management, to move ANIs from the Grey List to the White or Black Lists.

At 206, a Black List may be created. In embodiments, the Black List may be created manually and populated by the user, for example, using the interface that is also used to manage the White and Grey Lists.

At 208, the calls (or messages) may be processed based on the user's lists. In embodiments, calls on each list or on no list may be handled differently. For example, all calls coming from ANIs in White List may be completed as normal. All calls from unknown ANIs or ANIs in the Grey List may be handled based on a customer configured action. Examples of such customer configured action may include sending the call to Voicemail. Alternatively, the caller may be offered a CAPTCHA® or equivalent authentication mechanism. If authentication succeeds, the call may be completed as normal, if not, the ANI added to Grey List or Black List and the call rejected with Busy. Alternatively, the call may be processed by offering the user the ability to screen the call, such as by listening while the caller records a message on the user's voicemail. All calls from ANIs in the Black List may be rejected with Busy.

At 210, calls may be processed based on other user's and/or system lists. Processing of a call when the ANI belongs to a user's lists may occur as described above. However, calls from new unknown ANIs may also be received. Embodiments may process such calls based on the interaction between lists from different users. The key here is that one user may have another user (phone number) in a white list. In that case it would be reasonable to assume that the white list for the second user can be used to verify calls to the first user. This may be termed second degree white call verification. A user would have to have the option to choose if they allow their lists to be used for verification for a limited group, such as their white listed contacts, a larger, but still limited group, system wide, etc., or to opt out of list sharing. Users may also choose if they want to limit call protection to their individual lists or extend it to use lists of their contacts or even system wide. A similar approach could be provided with black lists. If a telephone number is black listed by any of a user's contacts, it may be considered as an unwanted call.

Embodiments may extend list handling further by, for example, providing three degree of separation (contact of contact) or even more degrees of separation of contact lists in verifying the call. Embodiments may use additional criteria for verification, for example a telephone number may be required to be whitelisted at least by two contacts. The same may be applicable to blacklisted calls. Embodiments may handle calls from telephone numbers found in a user's lists differently from calls from telephone numbers identified by lists belonging to contacts of the user. For example, calls from telephone numbers in a user's Black List may be rejected, while calls from telephone numbers in a Black List belonging to a contact of the user may be forwarded to voicemail.

It is to be noted that the use of three lists—White List, Grey List, and Black List is merely an example. For example, telephone calls may be advantageously handled using these three lists, while messages, SMS, MMS, IMESSAGE®, text message, and the like, may be advantageously handled using only two lists—White List and Black List. Embodiments may use a plurality of lists and handle calls and messages differently depending on which list the originator of the call or message is present in.

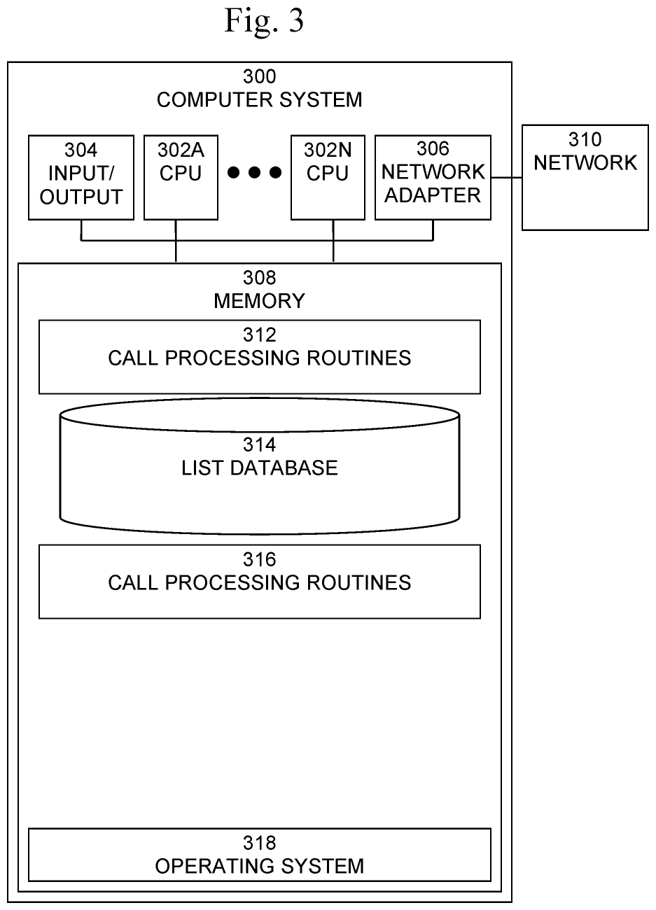

An exemplary block diagram of a computer system 300, in which processes and components involved in the embodiments described herein may be implemented, is shown in FIG. 3. Computer system 300 may be implemented using one or more programmed general-purpose computer systems, such as embedded processors, systems on a chip, personal computers, workstations, server systems, and minicomputers or mainframe computers, or in distributed, networked computing environments. Computer system 300 may include one or more processors (CPUs) 302A-302N, input/output circuitry 304, network adapter 306, and memory 308. CPUs 302A-302N execute program instructions in order to carry out the functions of the present communications systems and methods. Typically, CPUs 302A-302N are one or more microprocessors, such as an INTEL CORE® processor. FIG. 3 illustrates an embodiment in which computer system 300 is implemented as a single multi-processor computer system, in which multiple processors 302A-302N share system resources, such as memory 308, input/output circuitry 304, and network adapter 306. However, the present communications systems and methods also include embodiments in which computer system 300 is implemented as a plurality of networked computer systems, which may be single-processor computer systems, multi-processor computer systems, or a mix thereof.

Input/output circuitry 304 provides the capability to input data to, or output data from, computer system 300. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computer system 300. Memory 308 may include, for example, electronic memory devices, such as random-access memory (RANI), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 308 may vary depending upon the function that computer system 300 is programmed to perform. In the example shown in FIG. 3, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 3, memory 308 may include call processing routines 312, list database 314, user interface routines 316, and operating system 318. Call processing routines 312 may include software to perform call processing, as described above. List database 314 may provide storage of lists, such as the White List, Grey List, and Black List, as described above. User interface routines 316 may include software to allow a user to manage and edit list entries—add/delete/move/update entries, as described above. Operating system 318 may provide overall system functionality.

As shown in FIG. 3, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RANI), a read-only memory (ROM), an erasable programmable read-only memory (EPROM or Flash memory), a static random access memory (SRANI), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method, implemented in a computer system comprising a processor, memory accessible by the processor, and computer program instructions stored in the memory and executable by the processor, the method comprising:
receiving, at a call processing system, a call or message from an originator to a recipient user of the call processing system;
determining, at the call processing system, whether the originator of the call or message is present in at least one of a plurality of lists of identifiers of originators of calls or messages; and
handling, at the call processing system, the call or message differently based on which list of identifiers in which the originator is present.

2. The method of claim 1, wherein the originator of a call is identified based on an Automatic Number Identification (ANI).

3. The method of claim 1, wherein the originator of a message is identified based on an identifier associated with the message, the identifier comprising at least one of a telephone number, a non-telephone number digit strings, and a network address.

4. The method of claim 1, wherein the recipient user has a plurality of lists of identifiers of originators of calls or messages and the call is handled using the recipient user's plurality of lists.

5. The method of claim 4, wherein at least some other users of the call processing system other than the recipient user have lists of identifiers of originators of calls or messages and the call is handled using at some of the lists of identifiers of the other users.

6. A system comprising a processor, memory accessible by the processor, and computer program instructions stored in the memory and executable by the processor to perform:
receiving, at a call processing system, a call or message from an originator to a recipient user of the call processing system;
determining, at the call processing system, whether the originator of the call or message is present in at least one of a plurality of lists of identifiers of originators of calls or messages; and
handling, at the call processing system, the call or message differently based on which list of identifiers in which the originator is present.

7. The system of claim 6, wherein the originator of a call is identified based on an Automatic Number Identification (ANI).

8. The system of claim 6, wherein the originator of a message is identified based on an identifier associated with the message, the identifier comprising at least one of a telephone number, a non-telephone number digit strings, and a network address.

9. The system of claim 6, wherein the recipient user has a plurality of lists of identifiers of originators of calls or messages and the call is handled using the recipient user's plurality of lists.

10. The system of claim 9, wherein at least some other users of the call processing system other than the recipient user have lists of identifiers of originators of calls or messages and the call is handled using at some of the lists of identifiers of the other users.

11. A computer program product comprising a non-transitory computer readable storage having program instructions embodied therewith, the program instructions executable by a computer, to cause the computer to perform a method comprising:
receiving, at a call processing system, a call or message from an originator to a recipient user of the call processing system;
determining, at the call processing system, whether the originator of the call or message is present in at least one of a plurality of lists of identifiers of originators of calls or messages; and
handling, at the call processing system, the call or message differently based on which list of identifiers in which the originator is present.

12. The computer program product of claim 11, wherein the originator of a call is identified based on an Automatic Number Identification (ANI).

13. The computer program product of claim 11, wherein the originator of a message is identified based on an identifier associated with the message, the identifier comprising at least one of a telephone number, a non-telephone number digit strings, and a network address.

14. The computer program product of claim 11, wherein the recipient user has a plurality of lists of identifiers of originators of calls or messages and the call is handled using the recipient user's plurality of lists.

15. The computer program product of claim 14, wherein at least some other users of the call processing system other than the recipient user have lists of identifiers of originators of calls or messages and the call is handled using at some of the lists of identifiers of the other users.
